(19) United States
(12) Patent Application Publication
(10) Pub. No.: US 2026/0199938 A1
(43) Pub. Date: Jul. 16, 2026

(54) APPARATUS AND METHOD FOR A CLEANING DEVICE

(71) Applicant: Dyson Technology Limited, Malmesbury, Wiltshire (GB)

(72) Inventors: Burak KARADAG, Swindon (GB); Robert Matthew STRINGER, Swindon (GB)

(21) Appl. No.: 19/135,447

(22) PCT Filed: Dec. 4, 2023
(86) PCT No.: PCT/IB2023/062189

§ 371 Date: Jun. 4, 2025

(30) Foreign Application Priority Data
Dec. 7, 2022 (GB) 2218404.8

(51) Int. Cl. B08B 7/00; A47L 11/40; B01D 47/02; B01D 53/02; H05H 1/48

(52) U.S. Cl. CPC B08B 7/0035; A47L 11/4011; A47L 11/4041; A47L 11/4083; A47L 11/4091; B01D 47/02; B01D 53/02; H05H 1/48; A47L 2201/028; B01D 2253/102; B01D 2258/06; H05H 2245/40

(57) ABSTRACT

Provided is an apparatus for treating a cleaning member for cleaning a surface. The apparatus includes a first electrode provided at least partially within the cleaning member and a power source electrically connected to the first electrode for generating an electric field at the first electrode for generating a plasma at the cleaning member.

### FIELD OF THE INVENTION

The present invention relates to apparatuses and methods for treating part of a cleaning device and particularly, although not exclusively, to apparatuses and methods for treating a cleaning member of a cleaning device.

### BACKGROUND

There exist numerous different means of cleaning surfaces, such as floor surfaces, and these include the use of surface cleaning devices. Surface cleaning devices may include dry surface cleaners, such as vacuum cleaners, wet surface cleaners, such as powered mops, or wet and dry surface cleaners, which utilize a combination of wet and dry surface cleaning elements.

Wet surface cleaners typically include a cleaning member that may include a body covered in a cover material for contacting the surface being cleaned. The cleaning member may be provided with water in order to impart the water to the surface being cleaned as part of the cleaning process. The cleaning member may also absorb the water from the surface, and with it the contaminants being removed from the surface being cleaned. Dry cleaners may also include such a cleaning member, for example in the form of a brush head.

Wet surface cleaners may offer a deeper and more effective clean of a surface compared to dry surface cleaners. However, a drawback of typical wet cleaning devices is the cleaning members often provide a pathogen supporting environment after the device has been used. For example, when the wet cleaning device has been used to clean a surface the cleaning member will have absorbed a quantity of contaminated water, which can remain in the cleaning member until the next use of the device. This can lead to pathogen growth and the production of odours while the device is not being used, as well as pathogen spreading during subsequent uses of the device. The current solution to this problem is to remove and replace the cleaner head cover material, which causes unnecessary waste. If a wet cleaning device is used infrequently, this may even be required after each use of the device.

Attempts have been made to overcome this problem, for example using ultraviolet radiation or anion generators to treat the cleaning member. However, ultraviolet light and anions incident on the cleaning member typically only provide surface sterilization and fail to reach pathogens held deeper within the cleaning member. Further, the use of chemical disinfectants can also be inadequate due to the non-uniform porous structure of many conventional cover materials for cleaning members, which can provide safe pockets for pathogens to continue growing.

There is therefore a need to provide a means of adequately treating the cleaning device, and in particular the cleaning member of the cleaning device. The present invention has been devised in light of the above considerations.

### SUMMARY OF THE INVENTION

According to a first aspect, there is provided an apparatus for treating a cleaning member for cleaning a surface, the apparatus comprising: a first electrode provided at least partially within the cleaning member; and a power source electrically connected to the first electrode for generating an electric field at the first electrode for generating a plasma at the cleaning member.

The invention provides a means of treating a cleaning member, which may for example be part of a cleaning device for cleaning a surface, by generating a plasma at the cleaning member. The plasma is generated by way of a breakdown in the electric field generated at a first electrode provided at least partially within the cleaning member. In this way, the plasma generated by the breakdown of the electric field at the first electrode may partially, or fully, penetrate the cleaning member, thereby sterilizing the cleaning member using the plasma.

In other words, there is provided a means of treating, or sterilizing, a cleaning member by causing a plasma to pass at least partially through the cleaning member as a result of electric breakdown of a medium such as gas and/or liquid due to an electric field generated at a first electrode at least partially within said cleaning member.

In an embodiment, the term “treating” may be considered as causing any alteration in the state or condition of the cleaning member. For example, treating the cleaning member may include one or more of: cleaning; sterilizing; cleansing; and the like. The cleaning member may be any element suitable for cleaning a surface. For example, the cleaning member may be a part of a larger cleaning device used for cleaning a surface, wherein the cleaning member is one of the parts of the device that contacts the surface in order to affect the cleaning of said surface. The cleaning member may be a static element, or it may be a dynamic element. For example, the cleaning member may be adapted to roll across the surface being cleaned in order to affect the cleaning. In such an example, the cleaning member may be a cylindrical roller having a roller body surrounded by a cover material. The cover material may include one or more of: a porous material, such as a sponge material, in which case the cleaning member may be a sponge roller; a microfibre material, in which case the cleaning member may be a microfibre roller; a plurality of bristles, in which case the cleaning member may be a brush roller; and the like.

The plasma is generated by the electrical field generated at the first electrode. Electrical breakdown occurs when an electrical insulator is subject to a high enough voltage to cause it to suddenly become an electrical conductor and current flows through it. This occurs when the applied voltage exceeds the insulator's dielectric strength. In the examples of the apparatus described herein, the electrical insulator across which the electrical breakdown occurs is the air, a liquid or a mixture of air and liquid between the first electrode and an electric breakdown target outside the cleaning member, which may be another electrode or an electrical earth as described further below. For example, the electrical breakdown may occur across the air in and around the pores of a sponge material covering the cleaning member, the fibres of a microfibre material covering the cleaning member and/or the bristles of a brush. In the case where the cleaning member is wetted, the electrical breakdown may occur across a chain of air bubbles or impurities suspended in the liquid held by the cleaning member. If the applied voltage at the first electrode is sufficiently high, the electrical breakdown may also occur across liquid held by the cleaning member in addition to air suspended in liquid.

The first electrode may be formed of any suitable conductive material, or electrically insulated conductive material, and is provided at least partially within the cleaning member, such as at least partially within the cover material of the cleaning member. A non-conductive material may act as an electrode, especially in the case of a high frequency, high voltage power source being used. A conductive material may be coated with a thin layer of ceramic, such as anodized aluminium, to increase corrosion resistance. The first electrode may be provided fully within the cleaning member, such as fully within the cover material of the cleaning member. The term “within” is considered to mean inside an outer circumference of the cleaning member. The power source may be any source of electrical power suitable for generating an electrical field at the first electrode. The power source may be one or more of: a DC power source; a pulsed DC power source, such as nanosecond pulsed power source; an AC power source; a pulsed AC power source; and a combination of AC and DC power sources.

In the embodiment where the cleaning member is provided with only a first electrode provided at least partially within the cleaning member, the plasma may be generated between the first electrode and the surface being cleaned. Put another way, in the absence of another electrode, the electrical breakdown may occur between the first electrode and the surface being cleaned, which may act as an electrical earth. Thus, the plasma may be generated fully within, partially within and partially adjacent to, or fully adjacent to the cleaning member in order to treat the cleaning member. Where the plasma is generated in relation to the cleaning member is dictated by the positioning of the first electrode relative to the cleaning member.

The first electrode may take any shape suitable for use with the cleaning member according to the implementation of the invention. For example, where the cleaning member includes a roller, which may take the form of a cylinder that rolls across the surface being cleaned, the first electrode may also take a cylindrical shape. Thus, the first electrode may be provided concentrically around the body of the roller and within the outer circumference of the cleaning member, such as within a cover material of the cleaning member. The first electrode may be provided between the body of the roller and the cover material of the cleaning member. The first electrode may be electrically connected to the power source by any suitable means. For example, the first electrode may be electrically connected to the power source by way of a slip ring connector provided at an axel of the cylindrical cleaning member.

When electrical breakdown occurs, it will occur along the path of least resistance. In the case where the apparatus comprises only a first electrode as described above, the path of least resistance may be located where the distance between the first electrode and the surface being cleaned is minimized. If the first electrode is cylindrical and provided concentrically about a roller of the cleaning member, the electrical breakdown will likely occur between the lowest point of the first electrode, which may correspond to the centre of the portion of the roller that is in contact with the surface being cleaned. This point of electrical breakdown will change relative to the roller as it rolls across the surface and will remain at, or close to, the point of minimum separation between the first electrode and the surface. Accordingly, as the cleaning member passes over the surface, for example as the roller is rolled across the surface, the plasma will be generated at different portions of the cleaning member, thereby increasing the proportion of the cleaning member treated by the plasma.

In the case where the cleaning member includes a cover material, within which is provided at least part of the first electrode, the cover material may further comprise a plurality of nanoparticles and/or microparticles adapted to electrically interact with the first electrode. The plurality of particles may comprise one or more of: ferroelectric particles; piezoelectric particles; metallic particles; and dielectric particles. The plurality of nanoparticles and/or microparticles may be provided in a thin film on the cover material. By providing these nanoparticles and/or microparticles to the cover material, the average dielectric strength across the cleaning member may be reduced, which in turn encourages the electrical breakdown to occur, thereby encouraging the generation of plasma for treating the cleaning member.

In addition to the first electrode, the apparatus may further comprise a second electrode electrically connected to the power source. In this case, the power source may be adapted to generate the electric field between the first electrode and the second electrode. By using a second electrode, the location and shape of the plasma generated by the electrical breakdown between the first and second electrodes may be more accurately and precisely controlled, thereby improving the efficacy of the treatment of the cleaning member. In the case where the cleaning member is a roller and the first electrode is provided concentrically around the body of the roller, the first electrode may rotate as the roller rolls along the surface being cleaned as described above. In this case, the second electrode may remain stationary relative to the cleaning member and first electrode and, similarly to the example described above, the electrical breakdown will occur between the first and second electrodes at the point where the distance between the two electrodes is minimized. As the first electrode moves with the cleaning member and the second electrode remains stationary relative to the cleaning member, the region of the cleaning member being treated by the generated plasma changes as the cleaning member moves, thereby increasing the proportion of the cleaning member treated by the plasma.

The second electrode may be arranged relative to the first electrode and the cleaning member according to a number of different arrangements based on the implementation of the apparatus. For example, the first and second electrode, and the second electrode and the cleaning member, may be separated by an air gap. In this case, the electrical breakdown between the first and second electrodes occurs at least partially through the cleaning member, for example through a cover material of the cleaning member, and across the air gap between the cleaning member and the second electrode. Alternatively, the second electrode may be arranged in contact with the cleaning member, such as in physical contact with a cover material of the cleaning member. In this case, the electrical breakdown of between the first and second electrodes may occur exclusively through the portion of the cleaning member separating the first and second electrodes.

In a further example, the second electrode may be provided concentrically with the first electrode within the cleaning member. Put another way, both the first electrode and the second electrode may be provided inside of an outer circumference of the cleaning member, such as within a cover material of the cleaning member. In this case, the cleaning member may include a cylindrical roller and both the first and second electrodes may be cylindrical and provided concentrically about the roller. The first electrode may be provided within the circumference of the second electrode, or vice versa. The first and second electrodes may be separated by a portion of the cleaning member, which may be the focus of the plasma treatment. The first electrode may comprise a plurality of first electrodes, wherein each of the plurality of first electrodes is provided concentrically within the cover material. The plurality of first electrodes may be separated by one or more second electrodes.

In a yet further example, the apparatus may comprise a plurality of first electrodes, wherein each of the plurality of first electrodes may be provided as a fin extending radially through the cover material. In this case, the apparatus may also comprise a plurality of second electrodes provided as fins extending radially through the cover material and interspersed with the first electrodes. In this case, rather than the first and second electrodes being separated by a layer of the cleaning member, through which the plasma is generated by the electrical breakdown, the first and second electrodes may be separated by an arc, or section, of the cleaning member. Accordingly, the electrical breakdown may occur across an arc, or section, of the cleaning member.

In an embodiment, the apparatus may comprise a liquid reservoir for dispensing a liquid. The liquid may be any liquid suitable for cleaning a surface. For example, the liquid may comprise water or a solution of water and a cleaning agent. The apparatus may be configured such that the electric field acts on the dispensed liquid to create the plasma. In particular, the electrical breakdown may occur across the liquid, or air bubbles suspended in the liquid, provided or dispensed to the cleaning member from the liquid reservoir. In this case, the second electrode may be provided within the liquid reservoir. Thus, the plasma may travel through the cleaning member and into the liquid reservoir. Localized heating due to high voltage may create microscopic liquid vapour bubbles in the vicinity of the electrodes, which can encourage the onset of the electrical breakdown, as it is easier to ionize matter in gas form.

According to a second aspect of the invention, there is provided a cleaning device for cleaning a surface, the cleaning device comprising a cleaning member and the apparatus as described above. The cleaning device may be any device suitable for cleaning a surface. The cleaning device may be a dry cleaning device, such as a vacuum cleaner, or a wet cleaning device, such as a powered mop. The cleaning device may be a hand operated device, which may be at least partially driven or controlled by a user, or a robotic device. All, or part, of the apparatus described above may be provided within the cleaning device. For example, if the cleaning device is a powered device, the power source of the apparatus may also be the power source of the cleaning device. The cleaning member and the apparatus, or at least part of the apparatus, may be provided substantially within a cleaning head of the cleaning device.

The cleaning device may further comprise a secondary cleaning member. In this case, the apparatus for treating the cleaning members may further comprise a third electrode provided at least partially within the secondary cleaning member and electrically connected to the power source. The power source may then be adapted to generate the electrical field between the first electrode and the third electrode. In this case, the electrical field will be generated across part of both cleaning members. Therefore, the electrical breakdown, and so the plasma generation, will occur through at least part of both of the cleaning members. Accordingly, both of the cleaning members may be treated simultaneously by the same electrical breakdown between the first and third electrodes.

In a particular example, the cleaning member and the secondary cleaning member may be cylindrical cleaning members and the first and third electrodes may be provided concentrically within the cleaning member and secondary cleaning member, respectively. For example, the first electrode may be separated from the third electrode by a portion of a cover material provided about the cleaning member and a portion of a secondary cover material provided about the secondary cleaning member. The cleaning member may be in contact with the secondary cleaning member, or the cleaning member may be separated from the secondary cleaning member by an air gap, in which case the first electrode may be separated from the third electrode by a portion of the cover material, an air gap and a portion of the secondary cover material.

As described above, the electrical breakdown will occur along a path of least resistance. In the case where the cleaning device includes a secondary cleaning member as described above, this will be located at, or near, the area of minimum separation between the first and third electrodes. In the example where the first and third electrodes are cylindrical and provided concentrically within the cleaning members, the area of minimum separation between the first and third electrodes will be located between the points on the cylindrical first and third electrodes that are closest to each other. If the cylindrical cleaning members rotate during the operation of the cleaning device, the area of minimum separation between the first and third electrodes will change with respect to the cleaning member as it rotates, meaning that the electrical breakdown will occur across different positions on the cleaning members in use. Accordingly, the treatment of the cleaning member by the generated plasma may be distributed across the cleaning members as the cleaning device is used, thereby providing more complete treatment of the cleaning members.

In an embodiment, the cleaning device may further comprise an air filtration system adapted to filter air surrounding the cleaning head. The generation of plasma through electrical discharge can cause a number of by-product gases to be generated, such as ozone and nitrogen oxides. Accordingly, by providing an air filtration system, the air about the cleaning member of the cleaning device, which may contain some of these by-product gases when the system is in use, any by-product gases generated by the system can be removed. The air filtration system may comprise an air pump adapted to pump air from around the cleaning head and a filtration material in fluid communication with the air pump and adapted to filter the pumped air. The filtration material may comprise one or more of: a liquid held in a liquid reservoir of the wet cleaning device, such that the by-product gases are absorbed into the liquid; and an adsorbent filter material that can adsorb nitrogen oxide and ozone gases such as activated carbon or titanium dioxide. The filtered air may be provided back to the region about the cleaning member or may be exhausted from the cleaning device.

The cleaning device may also comprise a sensor in fluid communication with the cleaning member, the sensor being adapted to sense a gaseous by-product of the plasma. The cleaning device may further comprise a controller adapted to control an operation of the cleaning device based on an output of the sensor. For example, if the sensor detects a high proportion of gaseous by-product being produced at the cleaning member, which may be compared to a threshold value for example, the controller may be adapted to performed one or more of: activating the air filtration system; alerting the user; and preventing further operation of the device.

According to a third aspect of the invention, there is provided a cleaning system, the system comprising: a cleaning device as described above; and a docking station adapted to receive the cleaning device, wherein the power source is provided within the docking station, and wherein the first electrode is electrically connectable to the power source when the cleaning device is received in the docking station, the docking station comprising: a fourth electrode electrically connectable to the power source, wherein the power source is adapted to generate the electrical field between the first electrode and the fourth electrode. Thus, the apparatus for treating the cleaning member described above may be distributed between the cleaning device and the docking station. In particular, the power source for generating the electrical field at the first electrode may be located within the docking station rather than within the cleaning device itself. Therefore, the treatment of the cleaning member may be performed only when the cleaning device is received at the docking station, rather than when the device is in use.

In the case where the cleaning member is cylindrical and the first electrode is provided concentrically within the cleaning member, the docking station may include a means of causing the cleaning member to rotate when the cleaning device is received in the docking station, such as a motor connected to the cleaning member. The motor may be provided in the docking station or within the cleaning device and activated when the cleaning device is received by the docking station. Further, the fourth electrode may be held stationary relative to the rotating cleaning member, meaning that the point of minimum separation between the first and fourth electrodes will change with respect to the cleaning member as it rotates. Thus, when electrical breakdown occurs and the plasma is generated, the portion of the cleaning member being exposed to the generated plasma will change as the cleaning member rotates.

The docking station may further comprise a water bath, such that the cleaning member is at least partially submerged when the cleaning device is received in the docking station. The fourth electrode may be provided within the water bath in this case. The bubbles and impurities suspended in the water bath may act as mechanisms for encouraging the electrical breakdown between the first and fourth electrodes.

According to a fourth aspect of the invention, there is provided a method for treating a cleaning member of a cleaning device, the method comprising: generating an electric field at a first electrode provided at least partially within the cleaning member, thereby generating a plasma at the cleaning member by way of electrical discharge. The methods for treating the cleaning member may utilize any combination of the features described above in the treatment of the cleaning member.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic representation of an apparatus for treating a cleaning member wherein the first electrode is provided entirely within a cover material.

FIG. 2 shows a schematic representation of an apparatus for treating a cleaning member wherein the first electrode is provided partially within a cover material.

FIG. 3 shows a schematic representation of a cleaning device according to an aspect of the invention, wherein the apparatus comprises a second electrode in contact with the cleaning member.

FIG. 4 shows a schematic representation of a cleaning device according to a further aspect of the invention, wherein the second electrode is separated from the cleaning member by an air gap.

FIG. 5 shows a schematic representation of an apparatus for treating a cleaning member wherein the first and second electrodes are provided concentrically within a cover material.

FIG. 6 shows a schematic representation of an apparatus for treating a cleaning member having a liquid reservoir.

FIG. 7 shows a schematic representation of an apparatus for treating a cleaning member wherein the first and second electrodes are provided as ribs extending radially through a cover material.

FIG. 8 shows a schematic representation of an apparatus for treating a cleaning member wherein the cover material is provided with microparticles and/or nanoparticles.

FIG. 9 shows a schematic representation of an apparatus for treating a cleaning member and a secondary cleaning member.

FIG. 10 shows a schematic representation of a cleaning system comprising a cleaning device and a docking station.

FIG. 11 shows a schematic representation of a cleaning system comprising a cleaning device and a docking station having a water bath.

FIG. 12 shows a schematic representation of robotic cleaning device according to an aspect of the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

According to an aspect of the invention, there is provided an apparatus for treating a cleaning member for cleaning a surface, the apparatus comprising: a first electrode provided at least partially within the cleaning member; and a power source electrically connected to the first electrode for generating an electric field at the first electrode for generating a plasma at the cleaning member.

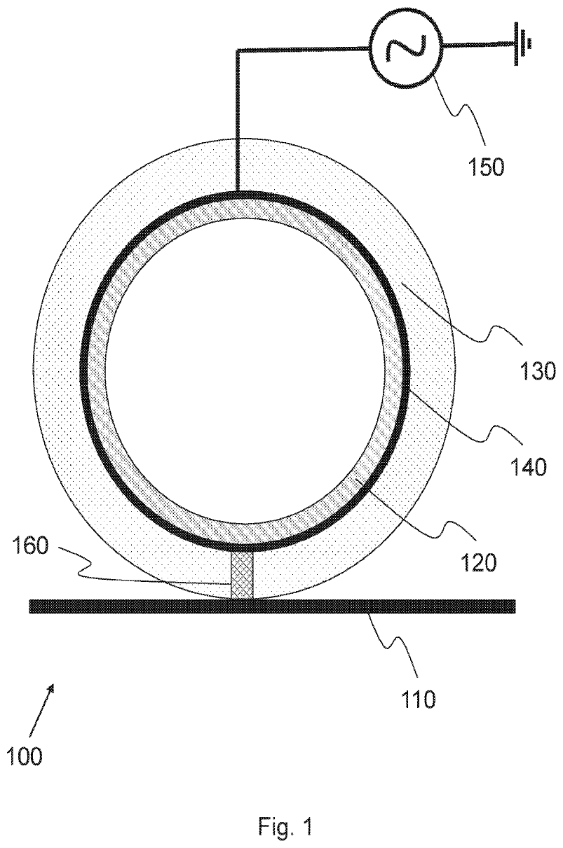

FIG. 1 shows a schematic representation of an apparatus 100 for treating a cleaning member for cleaning a surface 110. In the example shown in FIG. 1, the cleaning member is a cylindrical cleaning member comprising a roller body 120 and a cover material 130 provided about the roller body. Further, the apparatus comprises a first electrode 140 connected to a power source 150. In the example shown in FIG. 1, the first electrode is provided entirely within the cover material. The first electrode is also cylindrical and is provided concentrically about the roller body. The power source is a high voltage, high frequency AC power source. The frequency of the AC power source may be in the range of 0.1 to 100 kHz, such as between 1 to 10 kHz.

The plasma 160 is generated by the electrical field generated at the first electrode 140. Electrical breakdown occurs when an electrical insulator is subject to a high enough voltage to cause it to suddenly become an electrical conductor and current flows through it. This occurs when the applied voltage exceeds its breakdown voltage, which is a function of the insulator's dielectric strength, size and shape and the position of the electrode. In the example shown in FIG. 1, the electrical insulator across which the electrical breakdown occurs is the air and/or liquid between the first electrode and the surface 110 being cleaned, which acts as an electrical earth. In particular, the plasma 160 will be generated along an air and/or liquid path through the cover material 130 separating the first electrode from the surface. The air and/or liquid path may be defined according to the nature of the cover material. For a sponge cover material, the air path is defined through the porous structure of the sponge cover material.

The idealised shape of the electrical field generated by the first conductor 140 in the example shown in FIG. 1 will be similar to the idealised electric field for an infinite conducting cylinder and can be investigated using Gauss's Law, which is well understood. Taking the idealised shape of the electrical field for illustrative purposes, the shape of the electric field generated by the first conductor will be roughly cylindrical and will extend radially from the first conductor. The electric field will be stronger closer to the first conductor and weaker further away from the conductor.

Looking to FIG. 1, the distance between the first conductor 140 and the surface 110 is minimized at the point of contact of the cleaning member, and so the cover material 130, with the surface. Accordingly, the plasma 160 will be generated at this point of minimum separation between the first conductor and the surface 110 as this is where the electric field between the first conductor and the surface will be the strongest between two points.

In the example shown in FIG. 1, the cleaning member is a roller and is adapted to roll across the surface 110 when being used to clean the surface. As the first electrode 140 is provided concentrically about the roller body 120, the first electrode will also rotate as the cleaning member rolls across the surface. Accordingly, the point of minimum separation between the first conductor and the surface will effectively travel through the cover material 130 of the cleaning member, meaning that the plasma will be generated throughout the cleaning member as it rotates. Put another way, different parts of the cover material will pass through the point of minimum separation between the first conductor and the surface as the cleaning member rotates in use. After one full rotation, all of the cover material may have been treated by the generated plasma.

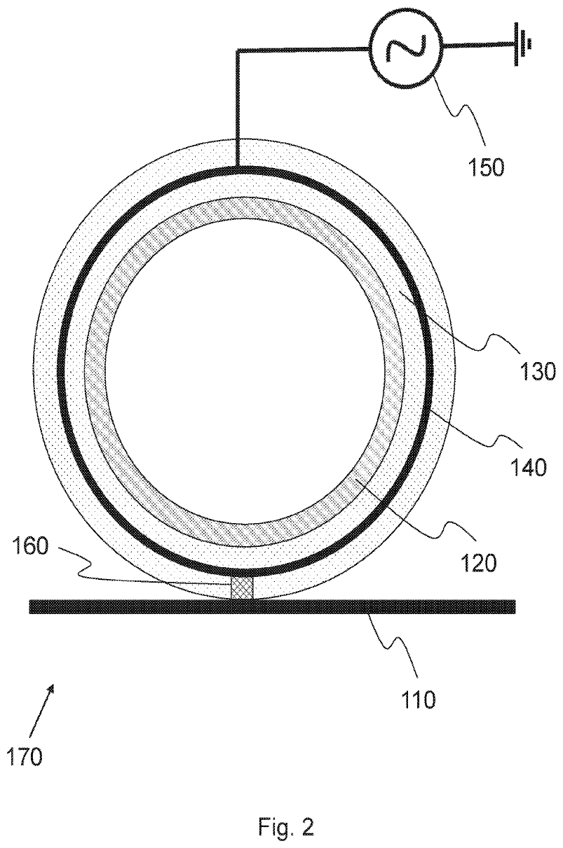

FIG. 2 shows a schematic representation of an apparatus 170 for treating a cleaning member for cleaning a surface 110 according to a further aspect of the invention. In the example shown in FIG. 2, the cleaning member is a cylindrical cleaning member comprising a roller body 120 and a cover material 130 provided about the roller body. Further, the apparatus comprises a first electrode 140 connected to a power source 150. In the example shown in FIG. 2, the first electrode is provided within the cover material, but is separated from the roller body by a portion of the cover material. The first electrode is also cylindrical and is provided concentrically about the roller body. The power source is a high voltage AC power source.

The apparatus 170 of FIG. 2 will function in much the same way as the apparatus 100 of FIG. 1, as described above. However, the plasma 160 generated will not be generated across the entire thickness of the cover material 130, but across the portion of the cover material separating the first electrode 140 and the surface.

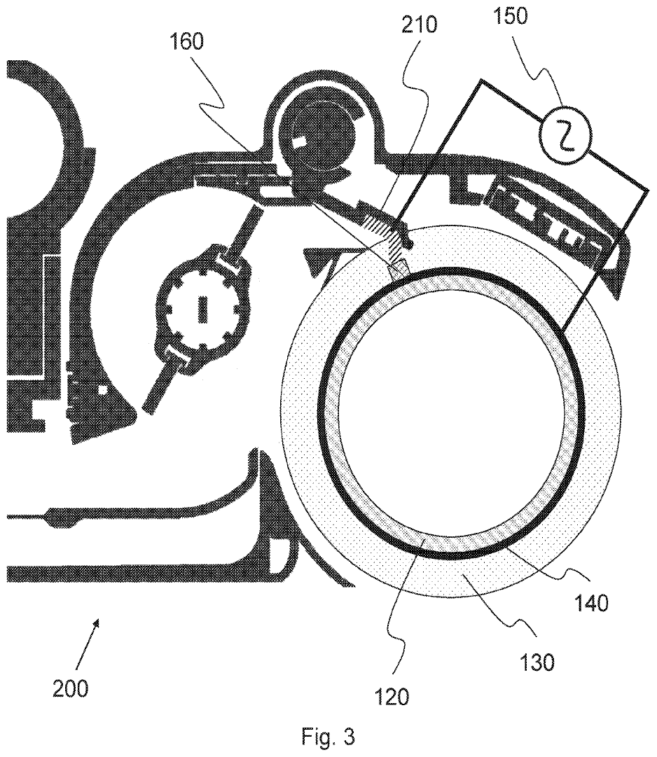

FIG. 3 shows a schematic representation of a cleaning device 200 according to an aspect of the invention. In particular, the example shown in FIG. 3 shows a representation of part of a cleaning head of a cleaning device, and more specifically, a wet cleaning device. The cleaning head shown in FIG. 3 may be part of a robotic or user-operated cleaning device.

The cleaning device 200 comprises a cleaning member having a roller body 120 and a cover material 130 provided about the roller body. In addition, the cleaning device comprises the apparatus as described above, which includes a first electrode 140 and a power source 150. The first electrode and power source are arranged about the cleaning member and behave in a similar manner to the apparatus shown in FIG. 1.

In addition to the first electrode 140, the apparatus further comprises a second electrode 210 electrically connected to the power source 150. Accordingly, the electric field generated by the power source is located between the first electrode and the second electrode, meaning that the location and shape of the plasma 160 generated by the electrical breakdown between the first and second electrodes may be more accurately and precisely controlled.

Similar to the examples shown in FIGS. 1 and 2, the cleaning member is a roller and is adapted to roll across the surface in use. As the first electrode 140 is provided concentrically about the roller body 120, the first electrode will also rotate as the cleaning member rolls across the surface. Accordingly, the point of minimum separation between the first electrode and the second electrode 210, which is held stationary relative to the cleaning member, will effectively travel through the cover material 130 of the cleaning member as it rotates. Therefore, the plasma will be generated throughout the cleaning member as it rotates. Put another way, different parts of the cover material will pass through the point of minimum separation between the first and second electrodes as the cleaning member rotates. After one full rotation, all of the cover material may have been treated by the generated plasma.

The second electrode 210 shown in FIG. 3 is incorporated into a mangle that is in contact with the cover martial 130. In this case, the electrical breakdown between the first and second electrodes may occur exclusively through the portion of the cleaning member separating the first and second electrodes, i.e., the cover material 130. The mangle applies pressure to the cover material 130 and can be used to remove excess liquid from the cover material as the cleaning member rotates.

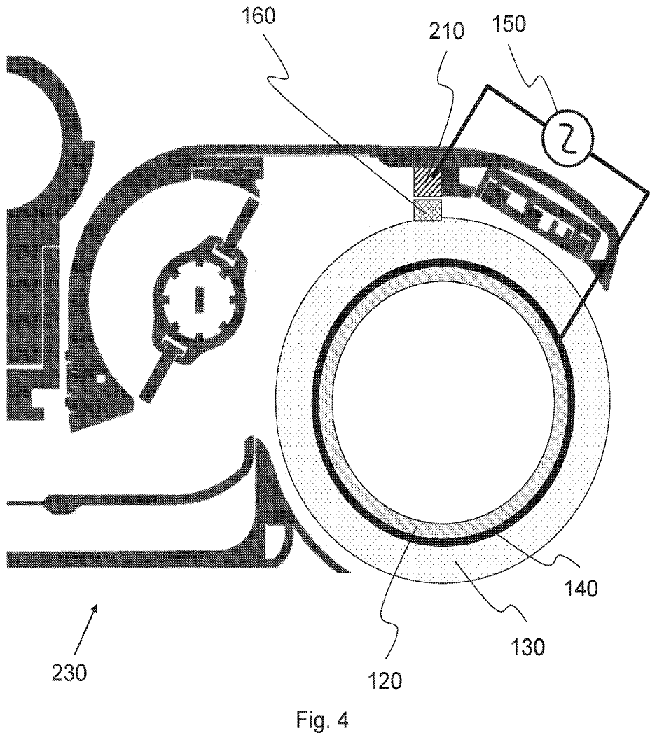

FIG. 4 shows a schematic representation of a cleaning device 230 according to a further aspect of the invention. The configuration of the cleaning device shown in FIG. 4 is similar to that shown in FIG. 3; however, in the example shown in FIG. 4, the second electrode 210 is separated from the first electrode 140, and the cover material 130, by an air gap. In this case, the electrical breakdown between the first and second electrodes generated plasma 160 through the cover material, and across the air gap between the cleaning member and the second electrode.

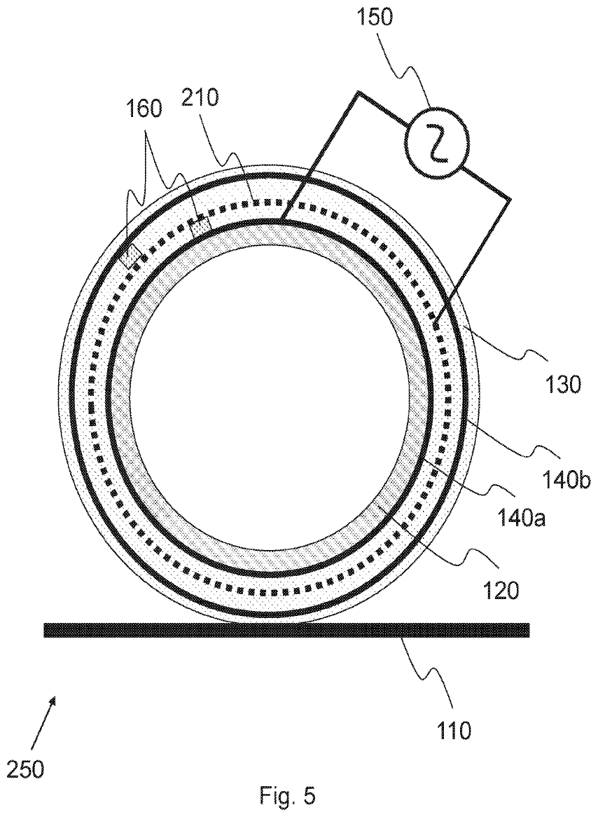

FIG. 5 shows a schematic representation of an apparatus 250 for treating a cleaning member according to a further aspect of the invention. In the example shown in FIG. 5, the cleaning member is a cylindrical cleaning member comprising a roller body 120 and a cover material 130 provided about the roller body. Further, the apparatus comprises a plurality of first electrodes, 140a and 140b and a second electrode 210 connected to a power source 150.

In the example shown in FIG. 5, the second electrode 210 is provided concentrically between the two first electrodes, 140a and 140b, such that the plasma 160 will be generated between each of the two first electrodes, 140a and 140b, and the second electrode. In the case of a sponge cover material, the electrodes may be provided as metal or metal oxide thin film coats on cylindrical surface layers of the sponge. In this case, both the first and second electrodes are provided within the cleaning member, meaning that the portion of the cleaning member separating the first and second electrode will be subject to the plasma treatment.

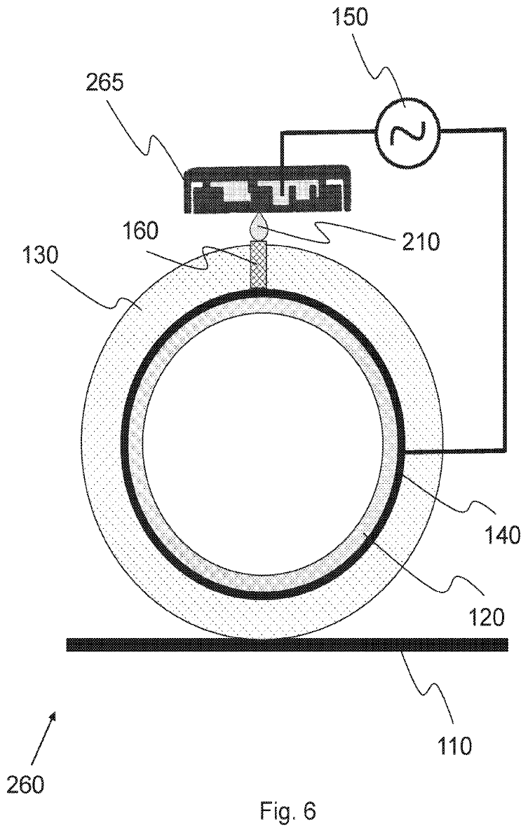

FIG. 6 shows a schematic representation of an apparatus 260 for treating a cleaning member according to a further aspect of the invention. In the example shown in FIG. 6, the apparatus further comprises a liquid reservoir 265 for dispensing a liquid to the cleaning member. For example, the cover material 130 may be a porous sponge cover material adapted to absorb the liquid dispensed from the reservoir and deposit said liquid onto the surface 110 being cleaned. The liquid may comprise water or a solution of water and a cleaning agent.

The apparatus 260 is configured such that the electric field acts on the dispensed liquid to create the plasma 160. In particular, the electrical breakdown may occur across air bubbles or impurities suspended in the liquid dispensed from the liquid reservoir and/or the liquid droplets themselves. In the example shown in FIG. 6, the second electrode may be provided within the liquid reservoir. In this case, the liquid droplets act as the second electrode 210. To deliver power to the liquid droplets, the liquid reservoir may include a conductive wire, or mesh, or a ceramic coated/anodized conductive material to increase corrosion resistance.

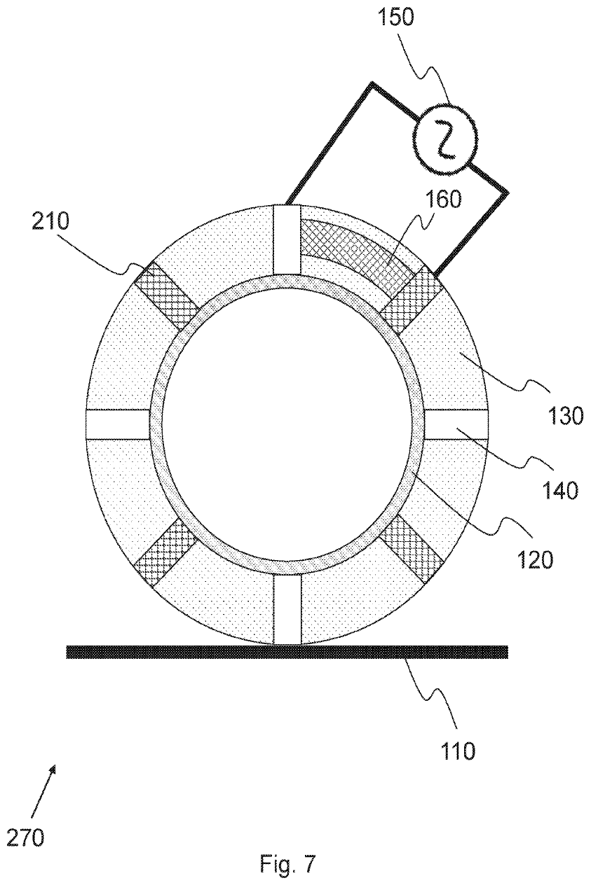

FIG. 7 shows a schematic representation of an apparatus 270 for treating a cleaning member according to a further aspect of the invention. In the example shown in FIG. 7, the apparatus comprises a plurality of first electrodes 140 and a plurality of second electrodes 210 provided as ribs extending radially through the cover material 130.

The second electrodes 210 are interspersed with the first electrodes 140 such that electric fields permeate the cover material 130 provided between each electrode. In this case, rather than the first and second electrodes being separated by a layer of the cleaning member, through which plasma is generated by the electrical breakdown, the first and second electrodes may be separated by an arc, or section, of the cleaning member. Accordingly, the plasma 1660 may be generated across an arc, or section, of the cover material.

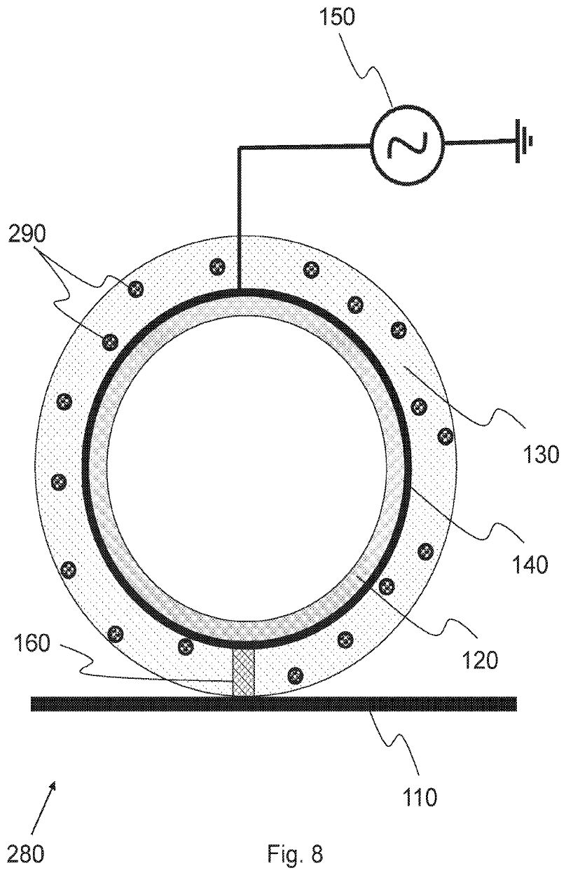

FIG. 8 shows a schematic representation of an apparatus 280 for treating a cleaning member according to a further aspect of the invention. In the example shown in FIG. 8, the cleaning member is a cylindrical cleaning member comprising a roller body 120 and a cover material 130 provided about the roller body. Further, the apparatus comprises a first electrode 140, connected to a power source 150, and provided concentrically around the roller body.

In the example shown in FIG. 8, the cover material 130 is provided with a plurality of particles 290, which may be microparticles and/or nanoparticles 290 adapted to electrically interact with the first electrode. The plurality of particles may comprise one or more of: ferroelectric particles; piezoelectric particles; metallic particles; and dielectric particles. The plurality of particles may be provided in a thin film on, or within, the cover material. By providing these particles to the cover material, the average dielectric strength across the cleaning member may be reduced, which in turn encourages the electrical breakdown to occur, thereby encouraging the generation of plasma for treating the cleaning member. Similar to the embodiment shown in FIG. 1, in the example of FIG. 8 the plasma 160 will be generated at the point of minimum separation between the first electrode and the surface, as there is no second electrode provided in this case. The distance between the first conductor 140 and the surface 110 is minimized at the point of contact of the cleaning member, and so the cover material 130, with the surface. Accordingly, the plasma 160 will be generated at this point of minimum separation between the first conductor and the surface 110 as this is where the electric field between the first conductor and the surface will be the strongest.

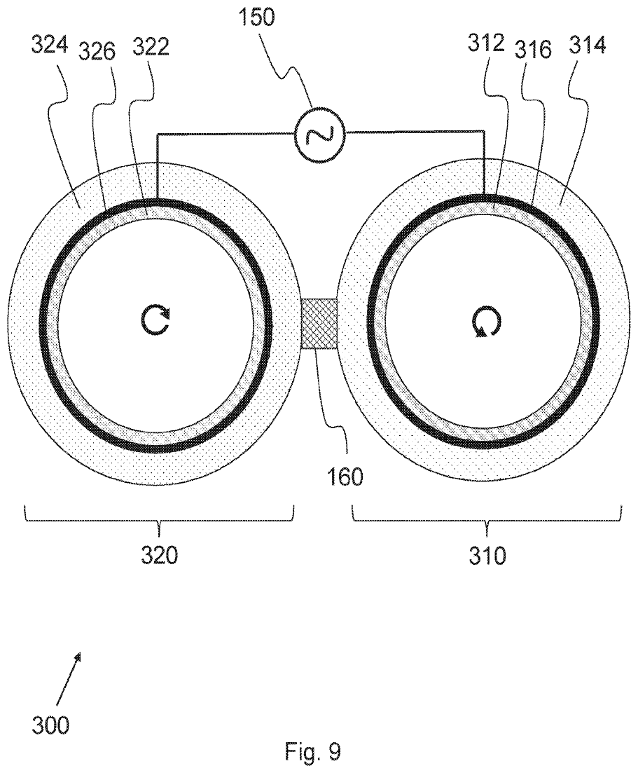

FIG. 9 shows a schematic representation of an apparatus 300 for treating a cleaning member 310 and a secondary cleaning member 320. In the example shown in FIG. 9, the cleaning member 310 is a cylindrical cleaning member comprising a roller body 312 and a cover material 314 provided about the roller body. Further, the apparatus comprises a first electrode 316, connected to a power source 150, and provided concentrically around the roller body. The secondary cleaning member 320 is also a cylindrical cleaning member comprising a secondary roller body 322 and a secondary cover material 324 provided about the secondary roller body. Further, the apparatus comprises a third electrode 316, connected to the power source 150, and provided concentrically around the secondary roller body.

In this case, the power source 150 is adapted to generate the electrical field between the first electrode 316 and the third electrode 326, meaning the electrical field will be generated across part of both cleaning members, through the cover material 314 and the secondary cover material 324. Therefore, the plasma 160 will be generated through at least part of both of the cleaning members. Accordingly, both of the cleaning members may be treated simultaneously by the same electrical breakdown between the first and third electrodes. In the example shown in FIG. 9, the cleaning member 310 and the secondary cleaning member 320 are separated by an air gap. However, as the cleaning members rotate in opposite directions, they may also be arranged in contact with each other.

As described above, the electrical breakdown will occur along the path of least resistance. In the example shown in FIG. 9, this will be located at the area of minimum separation between the first electrode 316 and the third electrode 326. As the cylindrical cleaning members, 310 and 320, rotate during the operation of the cleaning device, the area of minimum separation between the first and third electrodes will change with respect to the cleaning members as the rotates, meaning that the electrical breakdown will occur across different positions on the cleaning members in use. Accordingly, the treatment of the cleaning member by the generated plasma 160 may be distributed across the cleaning members as the cleaning device is used, thereby providing more complete treatment of the cleaning members.

Each of the apparatuses described above may be incorporated into cleaning device for cleaning a surface, such as the cleaning devices described above with respect to FIGS. 3 and 4. Such cleaning devices may also include an air filtration system adapted to filter air surrounding the cleaning head. The generation of plasma through electrical discharge can cause a number of by-product gases to be generated, such as ozone and nitrogen oxides. Accordingly, by providing an air filtration system, the air about the cleaning member of the cleaning device, which may contain some of these by-product gases when the system is in use, any by-product gases generated by the system can be removed. The air filtration system may comprise an air pump adapted to pump air from around the cleaning head and a filtration material in fluid communication with the air pump and adapted to filter the pumped air. In the case where the cleaning device is a vacuum cleaning device, the air pump for the air filtration system may also be the air pump for generating the vacuum. The filtration material may comprise one or more of: a liquid held in a liquid reservoir of the wet cleaning device, such that the by-product gases are absorbed into the liquid; and an activated carbon filter. The filtered air may be provided back to the region about the cleaning member or may be exhausted from the cleaning device.

The cleaning device may also comprise a sensor in fluid communication with the cleaning member, the sensor being adapted to sense a gaseous by-product of the plasma. The cleaning device may further comprise a controller adapted to control an operation of the cleaning device based on an output of the sensor. For example, if the sensor detects a high proportion of gaseous by-product being produced at the cleaning member, which may be compared to a threshold value for example, the controller may be adapted to performed one or more of: activating the air filtration system; alerting the user; and preventing further operation of the device.

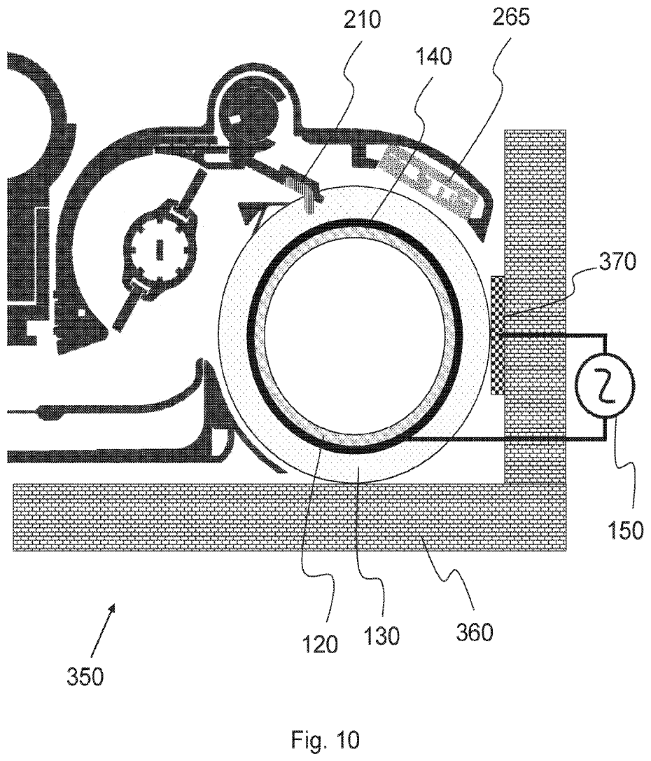

FIG. 10 shows a schematic representation of a cleaning system 350 comprising a cleaning device, an in this particular representation the cleaning device described above with respect to FIG. 3, and a docking station 360. The docking station 360 is adapted to receive the cleaning device.

In the example show in FIG. 10, the power source 150 is provided as part of the docking station 360. Therefore, the apparatus for cleaning the cleaning member of the cleaning device is spread across the cleaning device and the docking station. The cleaning member is a cylindrical cleaning member comprising a roller body 120 and a cover material 130 provided about the roller body. Further, the apparatus comprises a first electrode 140, connected to a power source 150, and provided concentrically around the roller body. The first electrode 140 is electrically connectable to the power source 150 when the cleaning device is received in the docking station 360. The docking station comprises a fourth electrode 370 electrically connectable to the power source 150. In this case, the power source is adapted to generate the electrical field between the first electrode and the fourth electrode. Therefore, the treatment of the cleaning member may be performed when the cleaning device is received at the docking station, rather than when the device is in use. It should be noted that the cleaning device may also include its own power source and a second electrode, as described above, in order to treat the cleaning member when the cleaning device is in use as well.

In the example shown in FIG. 10, the cleaning member is cylindrical and the first electrode 140 is provided concentrically within the cleaning member. Accordingly, the docking station may include a means of causing the cleaning member to rotate when the cleaning device is received in the docking station. For example, the docking station such as a motor connected to the cleaning member. Alternatively, the motor may be provided in the cleaning device and be activated when the cleaning device is received by the docking station. As the fourth electrode 370 is held stationary relative to the rotating cleaning member, the point of minimum separation between the first electrode 140 and fourth electrode 370 will change with respect to the cleaning member as it rotates. Thus, when electrical breakdown occurs and the plasma is generated, the portion of the cleaning member being exposed to the generated plasma will change as the cleaning member rotates.

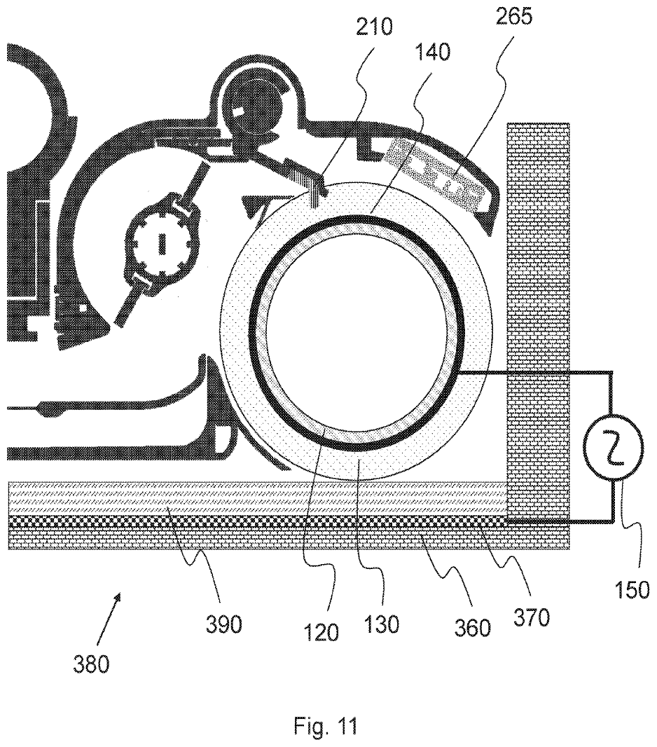

FIG. 11 shows a schematic representation of a cleaning system 380 comprising a cleaning device and a docking station 360 according to a further aspect of the invention. In the example shown in FIG. 11, the docking station further comprises a water bath 390, such that the cleaning member is at least partially submerged when the cleaning device is received in the docking station. In this case, the fourth electrode 370 may be provided within the water bath. The bubbles and impurities suspended in the water bath may act as mechanisms for encouraging the electrical breakdown between the first and fourth electrodes.

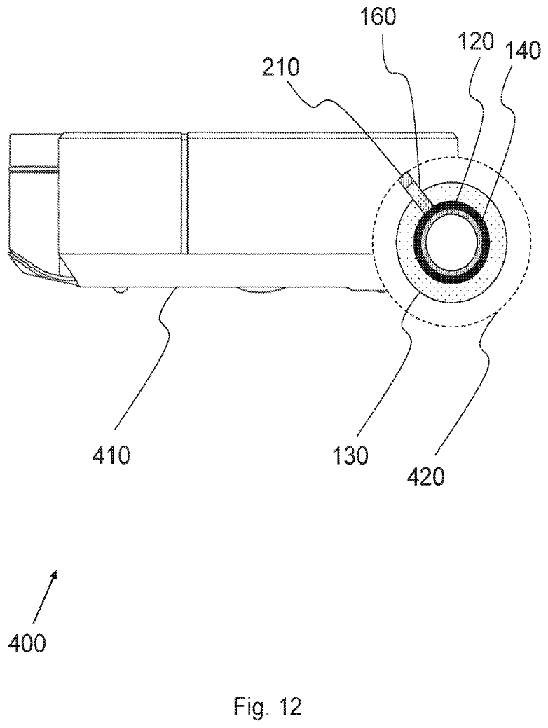

FIG. 12 shows a schematic representation 400 of robotic cleaning device 410 according to an aspect of the invention. FIG. 12 shows a cutaway view 420 of the cleaning member of the robotic cleaning device.

The examples given above have been described in the context of a user operated cleaning apparatus. However, the systems described above may be adapted to function with a plurality of types of cleaning appliances, such as a robotic cleaning device 410 as shown in FIG. 12. In particular, the robotic cleaning device may include a cleaning member having a roller body 120 and a cover material 130 as described above. In the example shown in FIG. 12, a first electrode 140 is provided within the cover material of the cleaning member and a second electrode 210 is provided external to the cleaning member, such that a plasma is generated between the first and second electrodes and through the cover material of the cleaning member as described in detail above. The robotic cleaning device may include any of the electrode arrangements described above and may function with the docking station described with respect to FIGS. 10 and/or 11 above.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An apparatus for treating a cleaning member for cleaning a surface, the apparatus comprising:
a first electrode provided at least partially within the cleaning member; and
a power source electrically connected to the first electrode for generating an electric field at the first electrode for generating a plasma at the cleaning member.

2. The apparatus as claimed in claim 1, wherein the cleaning member comprises a body and a cover material around the body, the first electrode provided at least partially within the cover material.

3. The apparatus as claimed in claim 2, wherein the apparatus further comprises a second electrode electrically connected to the power source, and wherein the power source is adapted to generate the electric field between the first electrode and the second electrode.

4. The apparatus as claimed in claim 3, wherein the first electrode and the second electrode are separated by an air gap.

5. The apparatus as claimed in claim 3, wherein the second electrode is in contact with the cleaning member.

6. The apparatus as claimed in claim 5, wherein the second electrode is provided concentrically with the first electrode within the cleaning member.

7. The apparatus as claimed in claim 6, wherein the first electrode comprises a plurality of electrodes, wherein each of the plurality of electrodes of the first electrode is provided concentrically within the cover material.

8. The apparatus as claimed in claim 3, wherein the apparatus further comprises a liquid reservoir for dispensing a liquid, and the apparatus is configured such that the electric field acts on the dispensed liquid to create the plasma, and wherein the second electrode is provided within the liquid reservoir.

9. The apparatus as claimed in claim 3, wherein the apparatus comprises a plurality of the first electrodes, wherein each of the plurality of first electrodes is provided as a fin extending radially through the cover material.

10. The apparatus as claimed in claim 9, wherein the apparatus comprises a plurality of the second electrodes provided as fins extending radially through the cover material and interspersed with the plurality of first electrodes.

11. A cleaning device for cleaning a surface, the cleaning device comprising the apparatus as claimed in claim 1 configured to treat the cleaning member.

12. The cleaning device as claimed in claim 11, wherein the cleaning member comprises a cover material and the cover material comprises one or more of:
a sponge material; and
a microfibre material.

13. The cleaning device as claimed in claim 12, wherein the cover material comprises a plurality of nanoparticles and/or microparticles adapted to electrically interact with the first electrode, the plurality of nanoparticles and/or microparticles comprising one or more of:
ferroelectric particles;
piezoelectric particles;
metallic particles; and
dielectric particles.

14. (canceled)

15. The cleaning device as claimed in claim 11, wherein the cleaning device comprises a secondary cleaning member, wherein the apparatus further comprises a third electrode provided at least partially within the secondary cleaning member and electrically connected to the power source, wherein the power source is adapted to generate the electrical field between the first electrode and the third electrode.

16. The cleaning device as claimed in claim 11, wherein the cleaning device further comprises an air filtration system adapted to filter air surrounding a cleaning head of the cleaning device, the air filtration system comprising:
an air pump adapted to pump air from around the cleaning head; and
a filtration material in fluid communication with the air pump and adapted to filter the pumped air.

17. The cleaning device as claimed in claim 16, wherein the filtration material comprises one or more of:
a liquid held in a liquid reservoir of the cleaning device; and
an adsorbent filter material.

18. The cleaning device as claimed in claim 11, wherein the cleaning device further comprises:
a sensor in fluid communication with the cleaning member, the sensor being adapted to sense a gaseous by-product of the plasma; and
a controller adapted to control an operation of the cleaning device based on an output of the sensor.

19. (canceled)

20. (canceled)

21. (canceled)

22. A cleaning system, the system comprising:
the cleaning device as claimed in claim 11; and
a docking station adapted to receive the cleaning device, wherein the power source is provided within the docking station, and wherein the first electrode is electrically connectable to the power source when the cleaning device is received in the docking station, the docking station comprising:
a fourth electrode electrically connectable to the power source, wherein the power source is adapted to generate the electrical field between the first electrode and the fourth electrode.

23. The cleaning system as claimed in claim 22, wherein the docking station further comprises a water bath, such that the cleaning member is at least partially submerged when the cleaning device is received in the docking station, and wherein the fourth electrode is provided within the water bath.

24. A method for treating a cleaning member of a cleaning device, the method comprising:
generating an electric field at a first electrode provided at least partially within the cleaning member, thereby generating a plasma at the cleaning member by way of electrical discharge.
